(19) United States
(12) Patent Application Publication
(10) Pub. No.: US 2018/0226073 A1
(43) Pub. Date: Aug. 9, 2018

(54) CONTEXT-BASED COGNITIVE SPEECH TO TEXT ENGINE

(71) Applicant: International Business Machines Corporation, Armonk, NY (US)

(72) Inventors: Rashida A. HODGE, Ossining, NY (US); Krishnan K RAMACHANDRAN, Campbell, CA (US); Laura I. RUSU, Endeavour Hills (AU); Gandhi SIVAKUMAR, Bentleigh (AU)

(21) Appl. No.: 15/425,750

(22) Filed: Feb. 6, 2017

(51) Int. Cl. G10L 15/18; G10L 15/26; G06F 17/24

(52) U.S. Cl. CPC G10L 15/1822; G10L 15/1815; G06F 17/241; G10L 15/265

(57) ABSTRACT

A method, computer program product, and system includes a processor(s) to obtain, over a communications network, media comprising at least one audio file, The processor(s) determines that the audio file includes human speech and extract the human speech from the audio file. The processor(s) contextualizes general elements of the human speech, based on analyzing metadata of the file. The processor(s) generates an unannotated textual representation of the human speech, where the unannotated textual representation includes spoken words. The processor(s) annotates the unannotated textual representation of the human speech, with indicators, where each indicator identifies a granular contextual element in the unannotated textual representation of the human speech. The processor(s) generates a textual representation of the human speech, by applying a template to the annotated textual representation, where the template defines values for the indicators in the annotated textual representation.

### BACKGROUND

Existing methods of converting speech (audio) to text (written) consist of dictation tools that take the words spoken by a user into a microphone in a specified language and map those words to known words in that language. The resulting text does not express the context of the communication (e.g., the emotion, the location, the time, the level of formality, the occasion, etc.) and is limited to spelling out punctuation for emphasis. For example, a text may include indications of punctuation, such as periods, exclamation points, and question marks. Based on the spoken dictation, the user can cause the text to include the names of symbols that express context, such as the names of emoticons (e.g., “smiley”, “wink”, “frown”, etc.).

Existing methods for context recognition in speech rely on pre-defining certain sounds or words and associating these sounds or words with emotions. Separate from dictation software, there exists a class of software that provides emotion recognition from speech, but accomplishes the recognition by utilizing acoustic features in machine learning techniques to classify audio input, based on an annotated corpus of utterances. These methods rely completely on having an annotated corpus and cannot be used in the absence of the corpus or for fine-grained emotion recognition, as conveyed by the content, rather than the acoustics. An example of speech including an emotion conveyed by the content would be a happy or sad announcement, said with a flat tone. In this situation, the content would indicate an emotion, but because the tone does not reflect the emotional state, existing methods would be unable to recognize the context. Certain methods attempt to compensate for this shortcoming by including pre-defined groups of words with each group representing one of the main six (6) emotions (i.e., happiness, sadness, anger, disgust, fear, and surprise). But the specific words must appear in the text for the context to be recognized. Meanwhile, other existing methods are limited to coordinating pre-defined sentences with certain emotions.

### SUMMARY

Shortcomings of the prior art are overcome and additional advantages are provided through the provision of a method for converting an audio communication to a non-audio format. The method includes, for instance: obtaining, by one or more processors, over a communications network, media comprising at least one audio file; determining, by the one or more processors, that the audio file includes human speech and extracting the human speech from the audio file; contextualizing, by the one or more processors, general elements of the human speech, based on analyzing metadata of the file; generating, by the one or more processors, an unannotated textual representation of the human speech, wherein the unannotated textual representation comprises spoken words in the human speech; annotating, by the one or more processors, the unannotated textual representation of the human speech, with indicators, wherein each indicator identifies a granular contextual element in the unannotated textual representation of the human speech, wherein the annotating comprises: extracting, by the one or more processors, sounds in the human speech, wherein the sounds comprise the spoken words, to identify granular context in the human speech; and annotating, by the one or more processors, portions of the human speech in the unannotated textual representation of the human speech comprising the contextualized general elements with the indicators; and generating, by the one or more processors, a textual representation of the human speech, by applying a template to the annotated textual representation, wherein the template defines values for the indicators in the annotated textual representation.

Shortcomings of the prior art are overcome and additional advantages are provided through the provision of a computer program product for converting an audio communication to a non-audio format. The computer program product comprises a storage medium readable by a processing circuit and storing instructions for execution by the processing circuit for performing a method. The method includes, for instance: obtaining, by one or more processors, over a communications network, media comprising at least one audio file; determining, by the one or more processors, that the audio file includes human speech and extracting the human speech from the audio file; contextualizing, by the one or more processors, general elements of the human speech, based on analyzing metadata of the file; generating, by the one or more processors, an unannotated textual representation of the human speech, wherein the unannotated textual representation comprises spoken words in the human speech; annotating, by the one or more processors, the unannotated textual representation of the human speech, with indicators, wherein each indicator identifies a granular contextual element in the unannotated textual representation of the human speech, wherein the annotating comprises: extracting, by the one or more processors, sounds in the human speech, wherein the sounds comprise the spoken words, to identify granular context in the human speech; and annotating, by the one or more processors, portions of the human speech in the unannotated textual representation of the human speech comprising the contextualized general elements with the indicators; and generating, by the one or more processors, a textual representation of the human speech, by applying a template to the annotated textual representation, wherein the template defines values for the indicators in the annotated textual representation.

Methods and systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 is a workflow of certain aspects of embodiments of the present invention that includes certain structural elements of some embodiments of the present invention;

FIG. 2 is a workflow illustrating certain aspects of an embodiment of the present invention;

FIG. 3 is an illustration of certain aspects of an embodiment of the present invention;

FIG. 4 is an illustration of certain aspects of embodiments of the present invention;

FIG. 5 is an illustration of certain aspects of embodiments of the present invention;

FIG. 6 is an illustration of certain aspects of embodiments of the present invention;

FIG. 7 is an illustration of certain aspects of embodiments of the present invention;

FIG. 8 is a workflow illustrating certain aspects of an embodiment of the present invention;

FIG. 9 depicts one embodiment of a computing node that can be utilized in a cloud computing environment;

FIG. 10 depicts a cloud computing environment according to an embodiment of the present invention; and

FIG. 11 depicts abstraction model layers according to an embodiment of the present invention.

### DETAILED DESCRIPTION

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention. As understood by one of skill in the art, the accompanying figures are provided for ease of understanding and illustrate aspects of certain embodiments of the present invention. The invention is not limited to the embodiments depicted in the figures.

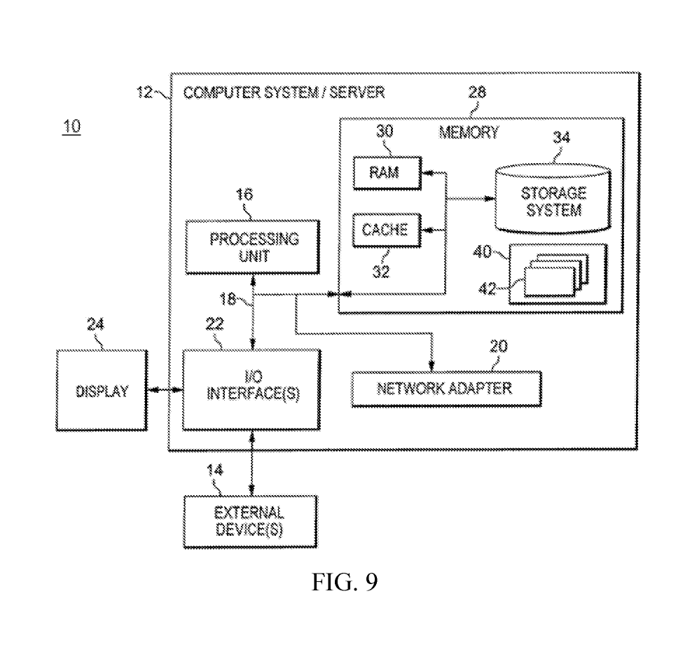

As understood by one of skill in the art, program code, as referred to throughout this application, includes both software and hardware. For example, program code in certain embodiments of the present invention includes fixed function hardware, while other embodiments utilized a software-based implementation of the functionality described. Certain embodiments combine both types of program code. One example of program code, also referred to as one or more programs, is depicted in FIG. 9 as program/utility 40, having a set (at least one) of program modules 42, may be stored in memory 28.

Embodiments of the present invention provide a computer-implemented method, system, and computer program product for identifying context in an oral communication, based on, for example, emotion and language, and transmitting the context in a written communication, for a specific audience. To convey the context of the communication, one or more programs may formulate a communication that includes symbols indicating the context, including but not limited to, punctuation, numbers, emoticons, and/or emoji. Emoticons are pictorial representations of facial expressions using punctuation marks, numbers, and letters, to express the feelings and/or mood of the individual in a written communication. Emoji are used like emoticons to express the feelings and/or mood of a communicator, but the images include various genres, including facial expressions, common objects, places, types of weather, and/or animals. By including context in communications, embodiments of the present invention provide an advantage over existing dictation technologies by proliferating context in transmissions that are passed down a communication chain. Text without context can often fail to convey the intent of the original speaker. By including the context in the text, one or more programs of an embodiment of the present invention ensure that the written communication accurately reflects the sentiments and intentions of the original speaker. Thus, embodiments of the present invention include a cognitive system that allows a Cognitive Speech to Text Engine (STTE) to identify a communication's context (e.g., emotion, language etc.) and transmit the context further in the communication chain (e.g., by including symbols, numbers, emoticons as appropriate/required), enabling these communications to be passed on in a communication chain (e.g., video/audio to hearing impaired, or transcripts of meetings for media/press release etc.).

Embodiments of the present invention include various aspects that are not available in existing speech recognition and/or context recognition technologies. For example, certain embodiments of the present invention include one or more programs that provide a granular representation of the context of a communication, by extracting certain aspects of an audio communication that cannot be extracted by existing systems, including, but not limited to, intonations, numbers, punctuations, and emotions. In embodiments of the present invention, one or more programs communicate these aspects by formulating a textual communication that includes relevant symbols (e.g., $), numbers, punctuations, as well as intonations, from the speech.

Embodiments of the present invention advantageously include program code that formulates textual communications from audio (e.g., live and/or pre-recorded) based in part on the audience who will receive the communication. In some embodiments of the present invention, rather than formulating a communication that includes a generic representation of certain contents of a speech or other voice communication, one or more programs formulate a communication and communicate the formulated communication to a target audience. For example, if a given target audience is hearing impaired, the program code may communicate content of audio media in sign language, using specific mapped kinematics for delivery by robots. If the given target audience is the general population, the program code may formulate and deliver a written communication. In some embodiments of the present invention, the one or more programs formulate a communication with instructions for communicating the content to different audiences. For example, the indicators of tone in a communication that is delivered to an audience of school-age children may vary from the indicators of tone in a communication targeted at a senior citizens' group.

Program code in embodiments of the present invention can also utilize the parameters of a target audience to adjust the formality of a communication it formulates. For example, in an embodiment of the present invention, if the communication is written, program code can utilize different context indicators (e.g., formal or informal) depending upon the audience. For a formal audience, one or more programs in certain embodiments of the present invention may transmit the word “happy” to accompany the text of the communication where the speech matches this context. For an informal audience, one or more programs may transmit an emoticon (e.g., [symbol] ), to indicate this context for the relevant portion of the speech. In determining what type of context indicator to utilize for a given audience, embodiments of the present invention generate and store mappings, for example, in a database, to indicate what indicator to use, for a given context, for a given type of audience. Once the one or more programs generate a mapping, the one or more programs can re-use the mapping when generating additional communications.

Embodiments of the present invention provide flexibility and diversity in translation of audio communications into text that is not offered in existing systems. For example, aspects of embodiments of the present invention include program code that defines various contexts for conversion from speech to text. Embodiments of the present invention are directed to implementing certain improvements in speech to text conversion. The improvements are possible because of the interconnectivity in the multi-processing environment, in which one or more programs of embodiments of the present invention, execute. Language is fluid and new developments occur rapidly. Embodiments of the present invention can take advantage of the temporal nature of language to produce accurate speech to text communications that reflect the content and context of a speech accurately, and in a communication that is customized for a given target audience. By executing in a dynamic network with ever updating resources and a changing number of resources, embodiments of the present invention can utilize the most current language data when converting speech to text. For example, as aforementioned, communications generated by one or more programs in embodiments of the present invention may be geared to one or more specific audiences.

In order to determine the requirements of the given audience, one or more programs continually learn, for example, through one or more machine learning algorithms, segments of language applicable to a given audience. A target audience that includes youth may communicate using new emoticons and/or emoji, which the program code may integrate into a communication to reflect context in a manner that is understood by this target audience. Meanwhile, data regarding the language preferences of a population of senior citizens may indicate less fluency with emoticons, so the one or more programs may generate a communication that utilizes additional punctuation to convey context. Below, Example 1, is a portion of written communication generated by one or more programs in an embodiment of the present invention that is meant to reflect exuberance to a teenage audience. Example 2 is the same portion, but the program code generated this text for an audience of senior citizens.

I can't believe you got a dog as a present [symbol] ! (Example 1)

I can't believe you got a dog as a present!!! (Example 2)

In order to appreciate the different and ever-changing requirements of various audiences, embodiments of the present invention include one or more programs that locate and synthesize available data to characterize the audience and formulate templates and rules for communication with these audiences. Embodiments of the present invention include one or more programs that generate and may continually update mappings between contexts and the manner in which these contexts can be represented in a textual communication. Thus, embodiments of the present invention efficiently target textual communications to specific audiences. This advantage is inextricably tied to computing at least because this aspect improves the efficiency and accuracy of speech to text communications by synthesizing data available across a communications network, including but not limited to, a cloud computing system, a field area network, or an ad hoc network, based on the connectivity potential of a computing node to the varied data sources. Embodiments of the present invention are also inextricably tied to computing because one or more programs in an embodiment of the present invention generate mappings, which these programs store and update, as dictated by changing norms in language. In an embodiment of the present invention, one or more programs establish and maintain a database to house the mappings.

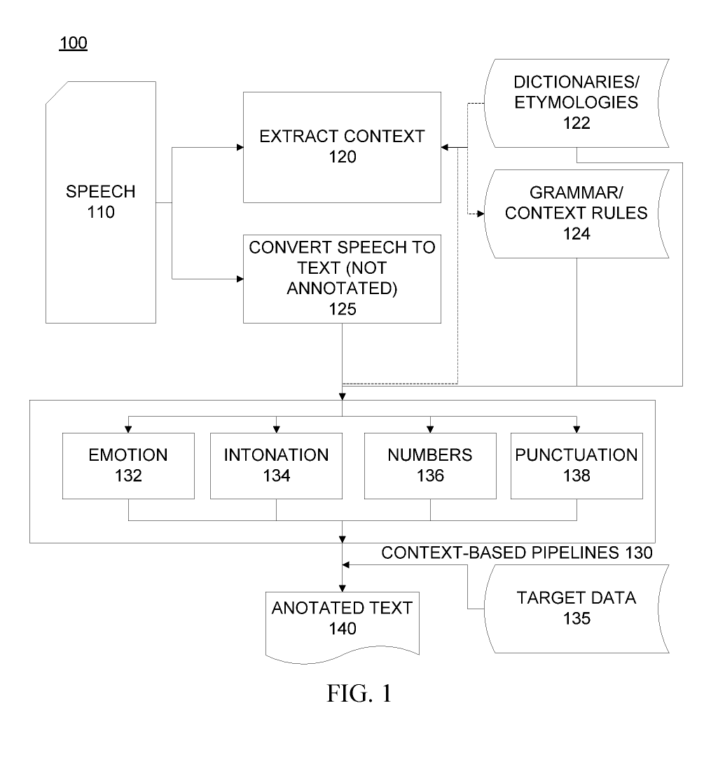

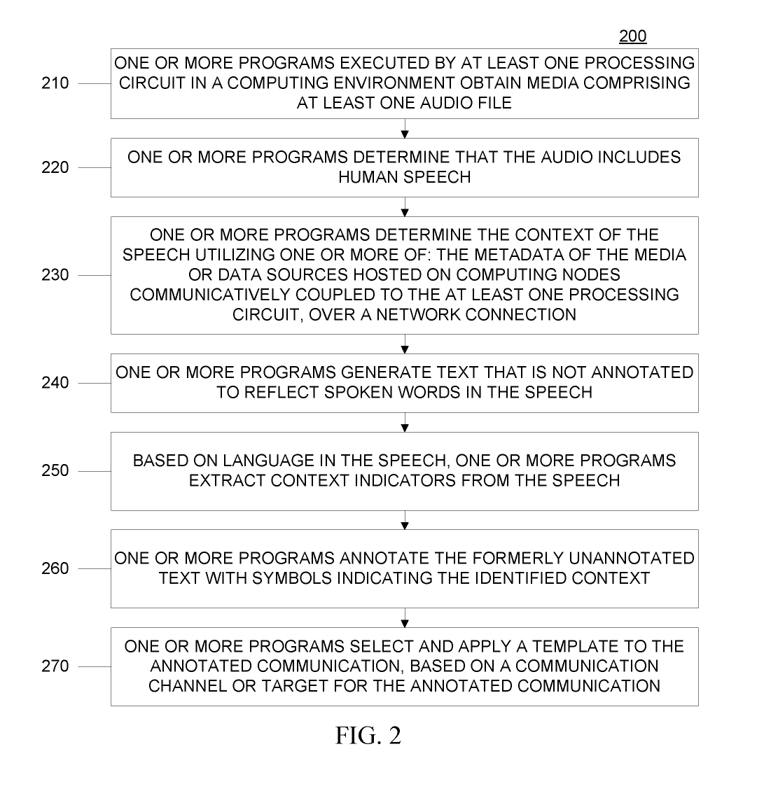

FIG. 1 illustrates aspects of some embodiments 100 of the present invention. Although certain functionalities of the one or more programs executed by one or more processing circuits in these embodiments 100 are illustrated as separate modules, the modular depiction is not a structural limitation, but, rather, is provided for ease of understanding. FIG. 2, which is discussed after FIG. 1, is a workflow 200 that illustrates aspects of embodiments of the present invention, which may also be discussed in FIG. 1.

Referring first to FIG. 1, as illustrated in FIG. 1, in embodiments of the present invention, one or more programs executing on at least one processing circuit obtain oral speech 100. The speech 100 in the form of a media file and/or a live (real-time) sound capture, via a recording device. Based on obtaining the speech 100, one or more programs extract context 120 data and convert the speech to (non-annotated) text 130. The one or more programs may perform the extraction and the conversion concurrently or sequentially (with either aspect occurring first or second).

In an embodiment of the present invention, one or more programs extract context 120 with the assistance of data sources, including but not limited to dictionaries/etymologies 122 and grammar/context rules 124. The one or more programs may utilize a communications connection to locate sources, such as online dictionaries, to provide this contextualization assistance. For example, in an embodiment of the present invention, the dictionaries/etymologies 122 may include Wikipedia and/or various social networks.

In some embodiments of the present invention, the context identified by one or more programs may include the speaker, the setting of the speech 100, the language of the speech 110, the location in which the speech 110 was/is being given, the of date the speech 110, and/or the communication style (e.g., formality) of the speech 110. This level of contextual elements are referred to as general elements, as these items contextualize a speech 110 overall, as opposed to indicating granular items within portions of the speech 110. In an embodiment of the present invention, having obtained a speech 110 that is an audio recording of President Barack Obama speaking at a press conference in Tokyo, Japan, the one or more programs may utilize outside sources, including but not limited to dictionaries/etymologies 122 and grammar/context rules 124, to determine that the following parameters are part of the context of the speech 100: the speaker is President Obama, the language is American English, the location is Japan, the date is Apr. 24, 2014, and the communication style is of an official type. In another example, when one or programs in an embodiment of the present obtain a speech 110 that is a recording of actor Russel Crowe giving an interview to a media outlet in Australia, the one or more program can extract the following context from the speech 110: the speaker is Russell Crowe, the language is Australian English, the location is Melbourne, Australia, the date of the interview is May 15, 2016, and the communication style is informal. In an embodiment of the present invention, the one or more programs generate a context date by extracting a date from packets that comprise the data and/or metadata of the audio file.

Returning to FIG. 1, in an embodiment of the present invention, one or more programs perform a natural language analysis of the non-annotated text and generate context data utilizing context-based pipelines 130. Each context-based pipeline includes program code that is configured to focus on a particular contextual area. FIG. 1 provides an example of a group of context-based pipelines 130 that may be included in an embodiment of the present invention: emotion 132, intonation 134, numbers 136, and punctuation 138. Unlike the general contextual elements described earlier, the program code in the context-based pipelines is configured to identify and/or extract granular contextual elements from the speech (i.e., contextual elements that refer to portions of the speech 110 and are not necessarily relevant to the speech 110 as a whole).

In certain embodiments of the present invention, one or more programs in the various pipelines of the context-based pipelines 130 process the context data and the text and annotate the text, to include annotation (e.g., context) indicators which, in this case, represent emotion, intonation, numbers, and punctuation, as relevant to the speech 110. The context-based pipelines in embodiments of the present invention can be understood as a speech to text conversion engine (STTE). These pipelines 130 include natural language processing programs of a category that may be referred to as context-based natural language word artists (NLWA). These pipelines 130, or mini-pipelines, may include a numeric context NLWA, a question NLWA, an emoticon NLWA, a punctuator NLWA, and a refiner NLWA. The one or more programs in the pipelines 130 may work in parallel on the unannotated text and/or may work sequentially. For example, in an embodiment of the present invention, the one or more programs of the refiner NLWA can execute after the remaining programs have completed execution.

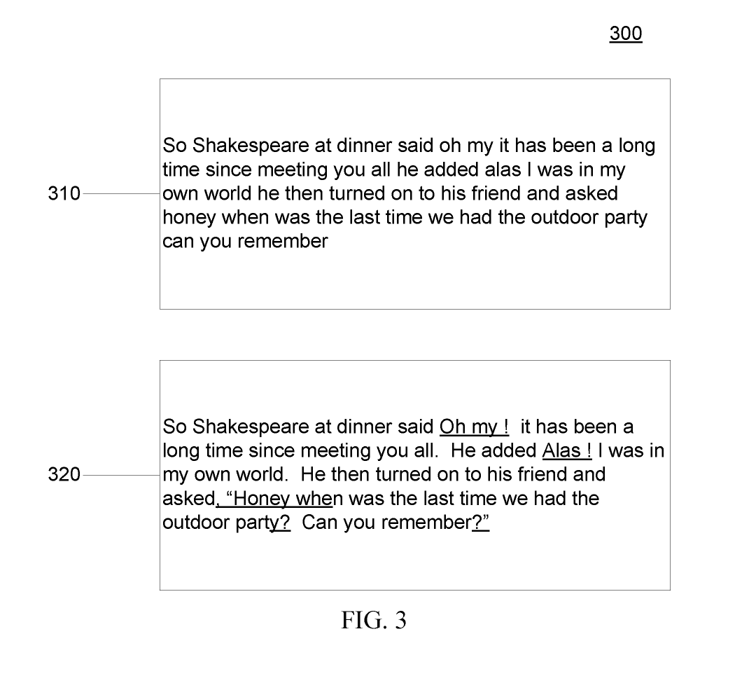

In embodiments of the present invention, one or more programs tag the text with (e.g., granular) context indicators, based on identifying emotional indicators in the text. Tagging the text with these indicators enables enhanced annotation of the text. FIG. 3 provides an example 300 of how text that is not annotated is tagged by one or more programs in the emotion 132 (FIG. 1) portion of the context-based pipelines 130 (FIG. 1).

FIG. 3 illustrates an example of a portion of text that is not annotated 310 and a portion of text that has been tagged with emotion indicators 320. As will be discussed later, one or more programs utilize these tags and target data to annotate the text. To that end, the portion of text that is not annotated 310 includes the text, “So Shakespeare at dinner said oh my it has been a long time since meeting you all he added alas I was in my own world he then turned on to his friend and asked honey when was the last time we had the outdoor party can you remember,” while the portion of text that has been tagged with emotion indicators 320 includes the text, “So Shakespeare at dinner said Oh my! it has been a long time since meeting you all. He added Alas! I was in my own world. He then turned on to his friend and asked, “Honey when was the last time we had the outdoor party? Can you remember?”

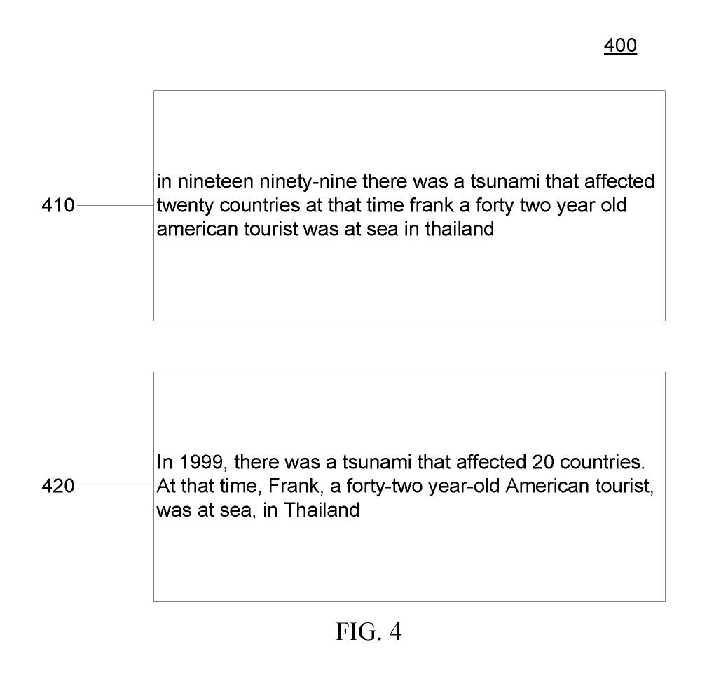

In embodiments of the present invention, one or more programs in the numbers 136 pipeline automatically convert text related to numerical values into syntactic representations of numbers that are context-specific. For example, in an embodiment of the present invention, the one or more programs format a date in text in a standard manner, based upon the extracted context. FIG. 4 gives an example 400 of how one or more programs in an embodiment of the present invention format numerical information in a communication. FIG. 4 includes the non-annotated text 410, which includes the text segment: “in nineteen ninety-nine there was a tsunami that affected twenty countries at that time frank a forty two year old american tourist was at sea in thailand.” Based on one or more programs in a context-based pipelines 130 (FIG. 1), including the punctuation 138 (FIG. 1) and number 136 (FIG. 1) functionalities, the annotated text 420 generated by the one or more programs, based on tagging the text with indicators in the context-based pipelines 130 (FIG. 1), includes the text segment: “In 1999, there was a tsunami that affected 20 countries. At that time, Frank, a forty-two year-old American tourist, was at sea, in Thailand.”

Returning to FIG. 1, in embodiments of the present invention, one or more programs receive target data 135, which includes data indicating the target population for the annotated text. Based on the target data 135, the one or more programs convert the annotation indicators to annotation in the text, generating an annotated text 140. For example, the one or more programs may convert an annotation indicator of happiness to a smiley face for a target population of teenagers, as seen in Example 1. In an embodiment of the present invention, the target data 135 includes the demographic information of the target population for the annotated text 140 as well as target-specific mappings from context indicators to symbolic representations of the indicators. The target data 135 may also include templates for annotating and/or formatting the text for different target populations. The target data may also include templates for formulating the text for delivery to different destinations. For example, the one or more programs may apply one template to generate text that is delivered to a robot as cues for sign language and may apply another template for posting the text in a social media feed, where the social media feed includes characters limits and various content rules. In an embodiment of the present invention, the one or more programs generate and deliver a communication that includes various contextual properties that a user and/or automated process may select, depending upon the target audience.

Because one or more programs in embodiments of the present invention customize a resultant communication for one or more target populations, embodiments of the present invention also include one or more programs that can change the context of an existing communication to accommodate a new and/or different target and/or context. For example, embodiments of the present invention include one or more programs that dynamically change the context of a given communication based on the target data 135. For example, in an embodiment of the present invention, the one or more programs may receive an instruction to electronically transmit a communication to a close friend. A user may convey this instruction by selecting a “mail to a close friend” option in a graphical user interface (GUI). Upon receiving this instruction, one or more programs revise a communication to convey a casual context.

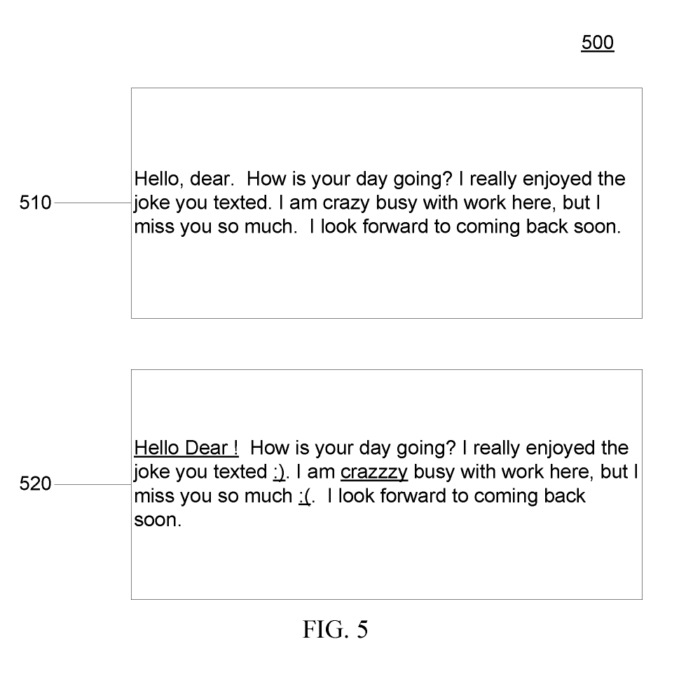

FIG. 5 includes an example 500 of a communication 510 generated by program code in embodiments of the present invention in a formal context and the same communication 520 revised for a casual context. In making this revision, the one or more programs may utilize target data 135 (FIG. 1). Emphasis is added in the revised communication 520 to show the changes made by the one or more programs. In the revised communication 520, one or more programs have added emoticons to convey the tone of the communication, as well as added additional consonants to highlight the pronunciation of the speaker. To that end, the communication 510 includes the text, “Hello, dear. How is your day going? I really enjoyed the joke you texted. I am crazy busy with work here, but I miss you so much. I look forward to coming back soon,” while the revised communication includes the text, “Hello Dear! How is your day going? I really enjoyed the joke you texted :). I am crazzzy busy with work here, but I miss you so much :(. I look forward to coming back soon.”

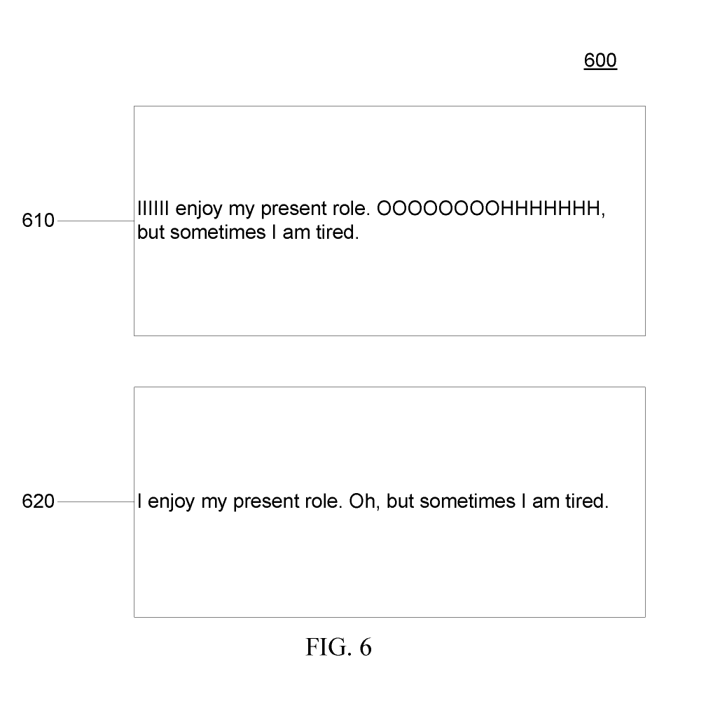

FIG. 6 is an example 600 of how one or more programs in an embodiment of the present invention can output a communication with different emphasis based on the context (e.g., specified by the target data 135, FIG. 1). FIG. 6 illustrates a portion of a communication 600 as generated by one or more programs in an embodiment of the present invention for a target that requires a first context 610 and for a target that requires a second context 620. In this example, the one or more programs produce the communication with the second context 620 is for an audience that is less familiar with the speaker than the audience for the first context 610. For the second context 620, intonations in the voice of the speaker are not noted and a more straightforward version of the text is presented. To that end, the communication utilizing the first context 610 includes the text, “IIIIII enjoy my present role. OOOOOOOOHHHHHHH, but sometimes I am tired,” while the communication utilizing the second context 620 includes the text, “I enjoy my present role. Oh, but sometimes I am tired.”

Returning to FIG. 1, in an embodiment of the present invention, the one or more programs may utilize the target data 135 to revise the language in which the one or more programs generate the annotated text 140. For example, the spelling of various words changes depending upon the geographic location of an audience. While annotated text 140 for a British group would include the words “organisation” the same annotated text 140 generated for an American group would include the word “organization.” Similarly, in an annotated text 140 bound for a British audience, the word “cookie” may be replaced with the word “biscuit.” In an embodiment of the present invention, the one or more programs that generate the annotated text 140 and can subsequently update the annotated text 140 to reflect the regional preferences/parameters of the audience.

As aforementioned, FIG. 2 is a flowchart that illustrates a workflow 200 that includes aspects of some embodiments of the present invention. Referring to FIG. 2, in an embodiment of the present invention, one or more programs executed by at least one processing circuit in a computing environment obtain media comprising at least one audio file (210). The one or more programs determine that the audio includes human speech (220). The one or more programs determine the context of the speech utilizing one or more of: the metadata of the media, data sources hosted on computing nodes communicatively coupled to the at least one processing circuit over a network connection (230). This network connection may include the Internet. The data sources may include social networks and reference websites, such as Wikipedia. The metadata may include bits in headers of packets that comprise the speech. As discussed in reference to FIG. 1, this initial context determination by the one or more programs refers to the one or more programs determining general contextual elements, i.e., contextual elements that are relevant to the entirety of the speech. Thus, in an embodiment of the present invention, the one or more programs determine one or more of the following contextual aspects of the speech: language, dialect, identity of the speaker, location in which the speech was given, the date the media was created, and/or the communication style.

In an embodiment of the present invention, the one or more programs generate text that is not annotated to reflect spoken words in the speech (240). In order to create a textual representation of the speech, the one or more programs may interface with existing dictation solutions. As discussed above, there are existing programs that convert spoken speech to text, however, the annotation provided by embodiments of the present invention is not available in these techniques. However, given that at this stage, one or more programs in an embodiment of the present invention generates text that is not annotated (in accordance with the functionality of embodiments of the present invention), leveraging the functionality of an existing solution for this aspect of an embodiment of the present invention may be advantageous economically.

In an embodiment of the present invention, the one or more programs, based on language in the speech, extract context indicators from the speech (250). As discussed in reference to FIG. 1, the context indicators extracted and/or identified by this program code include granular contextual elements, i.e., context information that is relevant to portions of the speech and not necessarily the entire speech. Thus, these indicators include, but are not limited to, emotion and intonation indicators. The one or more programs reference the language of the speech to extract the context in part because different emotions are expressed differently in different languages, different emotions are expressed using different words, based on the communication style at the time of speaking (e.g., formal, informal, official etc.). Thus, in embodiments of the present invention, the one or more programs utilize the general contextual elements to identify and extract the granular contextual elements. In an embodiment of the present invention, to extract the context indicators, the one or more programs identify and access relevant dictionaries/etymologies, based on the context (general and/or granular). With the assistance of the dictionaries/etymologies, the one or more programs spot applicable emotion keywords/expressions. In an embodiment of the present invention, the one or more programs extract intonation indicators (e.g., question, exclamation) by utilizing grammar rules relevant to the language of the speech.

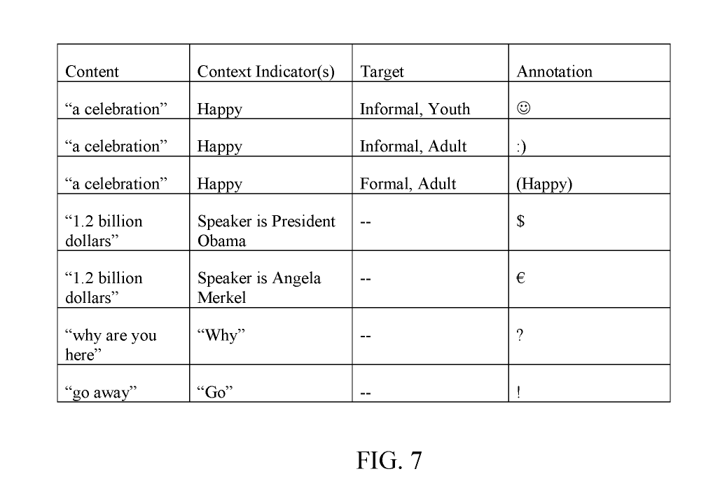

In an embodiment of the present invention, based on the context indicators, the one or more programs annotate the formerly unannotated text with symbols indicating the identified context (260). These annotations may include symbols or emoticons based on the language and the target to which the one or more programs will transmit the resultant communication. For example, the one or more programs may annotate a communication with a “smiley” emoticon based in a happiness indicator when a target is informal. The one or more programs may use the word “happy” in place of the happiness indicator for a formal target, including but not limited to, a communication intended for use as a press release, official meeting transcript, etc. FIG. 7 is a table that illustrates indicates certain context indicator-to-annotation mappings that may be generated by one or more programs in an embodiment of the present invention.

In an embodiment of the present invention, context indicators may include relevant emotions that certain portions of the speech convey, when heard orally. Thus, one or more programs annotate the text by tagging locations for relevant emotions. The one or more programs later replace the indicators with annotations.

In an embodiment of the present invention, a user and/or automated program can specify a context or combination of context for use by the one or more programs when annotating the communication. For example, the one or more programs may receive data indicating a desired context and/or target for the resultant communication. For example, in an embodiment of the present invention, the one or more programs may obtain data indicating that the communication should be generated in American English. Based on this data, the one or more programs may modify the communication and insert annotations consistent with this context. The one or more programs may also receive data describing a target. For example, based on receiving data that the target for the communication is a personal friend of the speaker, the one or more programs may formulate the communication using informal context annotations.

In an embodiment of the present invention, the one or more programs select and apply a template to the annotated communication, based on a communication channel or target for the annotated communication (270). For example, if the one or more programs adjust the format of the annotated communication based on, for example, that the intended target is a national newspaper and/or a local school newsletter. The one or more programs apply different styles to annotated communications by utilizing different communication templates.

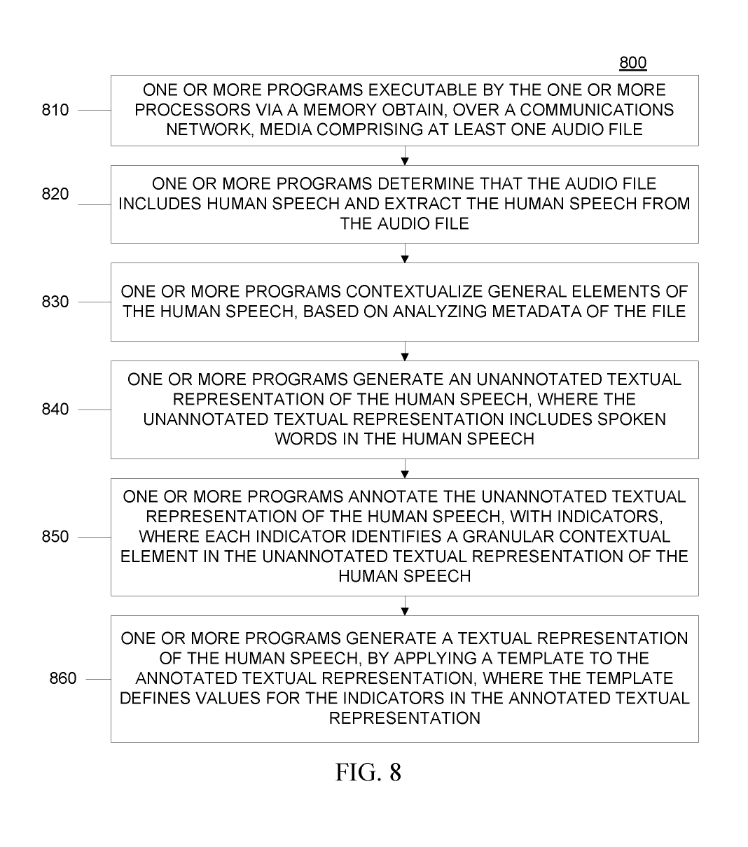

FIG. 8 is a workflow 800 illustrating aspects of some embodiments of the present invention. In embodiments of the present invention, one or more programs executable by one or more processors via a memory obtain, over a communications network, media comprising at least one audio file (810). The one or more programs determine that the audio file includes human speech and extract the human speech from the audio file (820). The one or more programs contextualize general elements of the human speech, based on analyzing metadata of the file (830). The one or more programs generate an unannotated textual representation of the human speech, where the unannotated textual representation includes spoken words in the human speech (840). The one or more programs annotate the unannotated textual representation of the human speech, with indicators, where each indicator identifies a granular contextual element in the unannotated textual representation of the human speech (850). In some embodiments of the present invention, to annotate the representation, the one or more programs extract sounds in the human speech, where the sounds include the spoken words, to identify granular context in the human speech and annotate portions of the human speech in the unannotated textual representation of the human speech, including the contextualized general elements of the human speech, with the indicators. The one or more programs generate a textual representation of the human speech, by applying a template to the annotated textual representation, where the template defines values for the indicators in the annotated textual representation (860).

Referring now to FIG. 9, a schematic of an example of a computing node, which can be a cloud computing node 10. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove. In an embodiment of the present invention, the computing resource(s) executing the one or more programs referenced in FIGS. 2-3 can be understood as cloud computing node 10 (FIG. 9) and if not a cloud computing node 10, then one or more general computing node that includes aspects of the cloud computing node 10.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 9, computer system/server 12 that can be utilized as cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs). Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

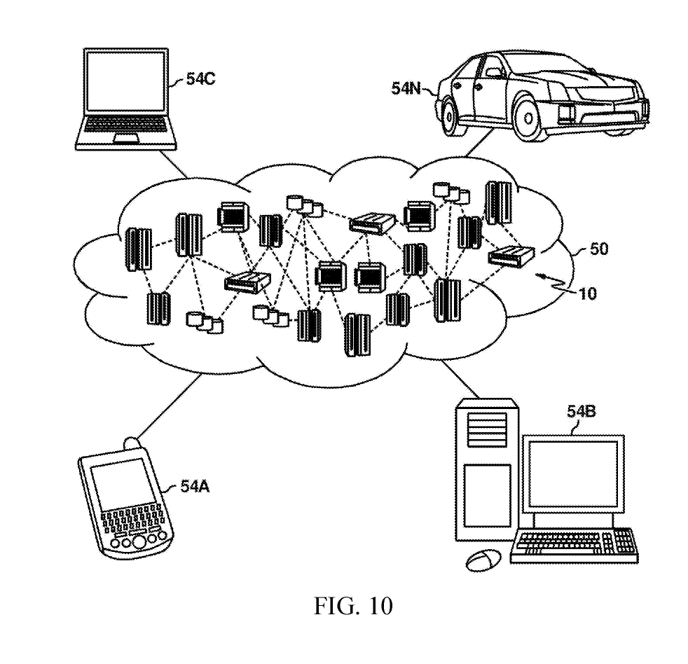

Referring now to FIG. 10, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 10 are intended to be illustrative only and that computing nodes 10 and cloud computing environment 50 can communicate with any type of computerized device over any type of network and/or network addressable connection (e.g., using a web browser).

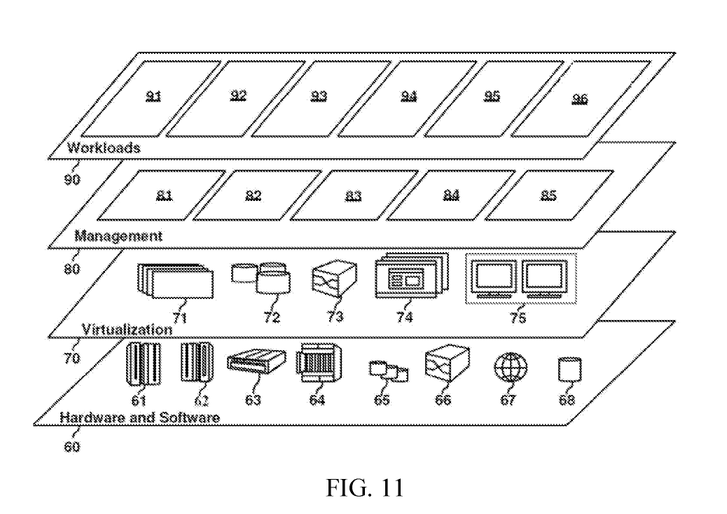

Referring now to FIG. 11, a set of functional abstraction layers provided by cloud computing environment 50 (FIG. 10) is shown. It should be understood in advance that the components, layers, and functions shown in FIG. 11 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and generating annotated text 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method, comprising:
obtaining, by one or more processors, over a communications network, media comprising at least one audio file;
determining, by the one or more processors, that the audio file includes human speech and extracting the human speech from the audio file;
contextualizing, by the one or more processors, general elements of the human speech, based on analyzing metadata of the file;
generating, by the one or more processors, an unannotated textual representation of the human speech, wherein the unannotated textual representation comprises spoken words in the human speech;
annotating, by the one or more processors, the unannotated textual representation of the human speech, with indicators, wherein each indicator identifies a granular contextual element in the unannotated textual representation of the human speech, wherein the annotating comprises:
extracting, by the one or more processors, sounds in the human speech, wherein the sounds comprise the spoken words, to identify granular context in the human speech; and
annotating, by the one or more processors, portions of the human speech in the unannotated textual representation of the human speech comprising the contextualized general elements with the indicators; and
generating, by the one or more processors, a textual representation of the human speech, by applying a template to the annotated textual representation, wherein the template defines values for the indicators in the annotated textual representation.

2. The computer-implemented method of claim 1, further comprising:
obtaining, by the one or more processors, target data comprising parameters of an audience for the annotated textual representation; and
selecting, by the one or more processors, the template based on the target data.

3. The computer-implemented method of claim 1, further comprising:
obtaining, by the one or more processors, communication channel data comprising delivery information for the annotated textual representation; and
selecting, by the one or more processors, the template based on the communication channel.

4. The computer-implemented method of claim 1, wherein extracting the sounds to identify indicators comprises identifying, in the human speech, context types selected from the group consisting of: emotion, intonation, numbers, and punctuation.

5. The computer-implemented method of claim 1, wherein the contextualizing further comprises:
identifying, by the one or more processors, data sources hosted on computing nodes communicatively coupled to the at least one processing circuit over a network connection; and
querying, by the one or more processors, the data sources to acquire data relevant to the general elements of the context of the human speech; and
contextualizing, by the one or more processors, the human speech, based on the data.

6. The computer-implemented method of claim 1, wherein the values in the annotated textual representation are selected from the group consisting of: emoticons, punctuation symbols, emoji, and descriptive text.

7. The computer-implemented method of claim 1, wherein the general elements of the human speech are selecting from the group consisting of: language, dialect, identity of speaker, location in which the human speech was given, file date, and communication style

8. The computer-implemented method of claim 1, wherein the contextualizing further comprises identifying elements indicating emotion in the human speech, the identifying comprising:
determining, by the one or more processors, a language if the human speech;
accessing, by the one or more processors, over a communications network, by the one or more processors, general elements of the human speech a dictionary for the language; and
based on the dictionary, identifying, by the one or more processors, keywords and expressions each indicating an emotion.

9. The computer-implemented method of claim 1, wherein the generating the textual representation of the human speech comprises inserting template values for the indicators in the annotated textual representation comprising mapped kinetics.

10. The computer-implemented method of claim 1, comprising:
transmitting, by the one or more processors, the textual representation to a robot communicatively coupled to the one or more processors over the communications network, wherein based on receiving the textual representation, the robot conveys the human speech utilizing in sign language, based on the textual representation.

11. A computer program product comprising:
a computer readable storage medium readable by one or more processors and storing instructions for execution by the one or more processors for performing a method comprising:
obtaining, by the one or more processors, over a communications network, media comprising at least one audio file;
determining, by the one or more processors, that the audio file includes human speech and extracting the human speech from the audio file;
contextualizing, by the one or more processors, general elements of the human speech, based on analyzing metadata of the file;
generating, by the one or more processors, an unannotated textual representation of the human speech, wherein the unannotated textual representation comprises spoken words in the human speech;
annotating, by the one or more processors, the unannotated textual representation of the human speech, with indicators, wherein each indicator identifies a granular contextual element in the unannotated textual representation of the human speech, wherein the annotating comprises:
extracting, by the one or more processors, sounds in the human speech, wherein the sounds comprise the spoken words, to identify granular context in the human speech; and
annotating, by the one or more processors, portions of the human speech in the unannotated textual representation of the human speech comprising the contextualized general elements with the indicators; and
generating, by the one or more processors, a textual representation of the human speech, by applying a template to the annotated textual representation, wherein the template defines values for the indicators in the annotated textual representation.

12. The computer program product of claim 11, the method further comprising:
obtaining, by the one or more processors, target data comprising parameters of an audience for the annotated textual representation; and
selecting, by the one or more processors, the template based on the target data.

13. The computer program product of claim 11, further comprising:
obtaining, by the one or more processors, communication channel data comprising delivery information for the annotated textual representation; and
selecting, by the one or more processors, the template based on the communication channel.

14. The computer program product of claim 11, wherein extracting the sounds to identify indicators comprises identifying, in the human speech, context types selected from the group consisting of: emotion, intonation, numbers, and punctuation.

15. The computer program product of claim 11, wherein the contextualizing further comprises:
identifying, by the one or more processors, data sources hosted on computing nodes communicatively coupled to the at least one processing circuit over a network connection; and
querying, by the one or more processors, the data sources to acquire data relevant to the general elements of the context of the human speech; and
contextualizing, by the one or more processors, the human speech, based on the data.

16. The computer program product of claim 11, wherein the values in the annotated textual representation are selected from the group consisting of: emoticons, punctuation symbols, emoji, and descriptive text.

17. The computer program product of claim 11, wherein the general elements of the human speech are selecting from the group consisting of: language, dialect, identity of speaker, location in which the human speech was given, file date, and communication style

18. The computer program product of claim 11, wherein the contextualizing further comprises identifying elements indicating emotion in the human speech, the identifying comprising:
determining, by the one or more processors, a language if the human speech;
accessing, by the one or more processors, over a communications network, by the one or more processors, general elements of the human speech a dictionary for the language; and
based on the dictionary, identifying, by the one or more processors, keywords and expressions each indicating an emotion.

19. The computer program product of claim 11, wherein the generating the textual representation of the human speech comprises inserting template values for the indicators in the annotated textual representation comprising mapped kinetics, and the method further comprises:
transmitting, by the one or more processors, the textual representation to a robot communicatively coupled to the one or more processors over the communications network, wherein based on receiving the textual representation, the robot conveys the human speech utilizing in sign language, based on the textual representation.

20. A system comprising:
a memory;
one or more processors in communication with the memory; and
program instructions executable by the one or more processors via the memory to perform a method, the method comprising:
obtaining, by the one or more processors, over a communications network, media comprising at least one audio file;
determining, by the one or more processors, that the audio file includes human speech and extracting the human speech from the audio file;
contextualizing, by the one or more processors, general elements of the human speech, based on analyzing metadata of the file;
generating, by the one or more processors, an unannotated textual representation of the human speech, wherein the unannotated textual representation comprises spoken words in the human speech;
annotating, by the one or more processors, the unannotated textual representation of the human speech, with indicators, wherein each indicator identifies a granular contextual element in the unannotated textual representation of the human speech, wherein the annotating comprises:
extracting, by the one or more processors, sounds in the human speech, wherein the sounds comprise the spoken words, to identify granular context in the human speech; and
annotating, by the one or more processors, portions of the human speech in the unannotated textual representation of the human speech comprising the contextualized general elements with the indicators; and
generating, by the one or more processors, a textual representation of the human speech, by applying a template to the annotated textual representation, wherein the template defines values for the indicators in the annotated textual representation.
